(19) United States
(12) Patent Application Publication
(10) Pub. No.: US 2021/0208452 A1
(43) Pub. Date: Jul. 8, 2021

(54) DISPLAY PANEL AND METHOD OF MANUFACTURING THE SAME

(71) Applicants: HKC Corporation Limited, Shenzhen City, Guangdong (CN); Chongqing HKC Optoelectronics Technoology Co.., Ltd., Chongqing (CN)

(72) Inventor: Yunqin HU, Chongqing (CN)

(21) Appl. No.: 16/064,399

(22) PCT Filed: Jan. 23, 2018
(86) PCT No.: PCT/CN2018/073766

§ 371 Date: Jun. 20, 2018

(30) Foreign Application Priority Data
Nov. 3, 2017 (CN) 2017711072235.1

(51) Int. Cl. G02F 1/1335

(52) U.S. Cl. CPC G02F 1/133516; G02F 1/133512

(57) ABSTRACT

The present disclosure is related to a display panel and a method for manufacturing the same. The display panel comprises a first substrate, a second substrate disposed in parallel with the first substrate, a light shielding layer disposed on the first substrate and defined a plurality of pixel areas, a color filter layer disposed on the plurality of pixel areas, the color filter layer including a first colored resist layer, a second colored resist layer, a third colored resist layer and a fourth colored resist layer, a transparent electrode layer disposed on the color filter layer, and wherein the fourth colored resist layer comprises a plurality of different colored resistor materials sequentially stacked from bottom to top.

### FIELD OF THE INVENTION

The present disclosure relates to a color filter layer of a display panel, and more particularly to a liquid crystal display panel and a manufacturing method thereof.

### BACKGROUND OF THE INVENTION

The liquid crystal display panel is commonly composed of a color filter substrate (CF), a thin film transistor array substrate (TFT Array Substrate), and a liquid crystal layer (LC Layer) disposed between the two substrates. According to the working principle, the liquid crystal molecules of the liquid crystal layer are controlled to tilt by applying driving voltage on the two glass substrates, and refracted the light rays of the backlight module to generate images. According to different orientation modes of liquid crystals, the liquid crystal display panel on the current mainstream market can be divided into the following types: Vertical Alignment (VA) type, Twisted Nematic (TN) type, Super Twisted Nematic (STN) type, In-Plane Switching (IPS) type and Fringe Field Switching (FFS) type.

The liquid crystal display with vertical alignment (VA) modes such as a patterned vertical alignment (PVA) type liquid crystal display or a multi-domain vertical alignment (MVA) type liquid crystal display device, in the meanwhile, the patterned vertical alignment type employs the edge field effect and the compensation plate to achieve the wide view angle function. The multi-domain vertical alignment type divides one pixel into a plurality of regions, and uses a protrusion or a specific pattern structure to conduct the liquid crystal molecules located in different areas can be tilted in different directions so as to achieve the effects of wide view angle and the improvement of penetration rate.

In an In-Plane Switching mode or a Fringe Field Switching mode, by applying an electric field containing a component that is substantially parallel to the substrate so that correspondingly driving the liquid crystal molecules reoriented (switched) in the direction parallel to the plane of the substrate. Both of the In-Plane Switching type liquid crystal display panel and the Fringe Field Switching type liquid crystal display panel have the advantages of wide view angle. However, due to the wavelength of the blue light is shorter comparing with the red light and green light, the retardation requirement of the blue light for the same transmittance (Transmittance) is smaller than the retardation requirement of the red light and green light, so that the Voltage-dependent transmittance (VT) curves of the red light, green light and blue light are different. Also the transmittance of the red light, green light and blue light in the films such as the polyimide film (PI), planarization layer (PFA), overcoat layer (OC) and the likes are different, therefore the color cast problem can also be caused.

The conventional pixels are composed of three sub-pixels of red, green, and blue (i.e., RGB). Since the resolution of a display panel product is improved, the density of pixels is increased accordingly, and therefore the transmittance is greatly reduced. Once the transmittance is reduced, more light emitting diodes (LEDs) of a backlight are required to maintain the same brightness of the display panel. Compared with a conventional three sub-pixels of red, green, and blue (RGB) technology, the four sub-pixels of red, green, blue and white (RGBW) technology is based on original RGB three primary color composition pixels, and then added with a white sub-pixel. An RGBW four color pixels is formed to improve the transmittance of a display panel, therefore the power consumption is reduced and the cost of the backlight module is reduced accordingly. However, to fabricate the RGBW four color pixels it needs four processes to coat each of the red, green, blue and white (RGBW) color resistors on the color filter substrate, therefore the material cost of the color filter substrate is increased and the manufacturing process is relatively complicated.

### SUMMARY OF THE INVENTION

In order to solve the above technical problems, it is an object of the present invention to provide a color filter layer, and more particularly, to a display panel and a method for manufacturing the same, simplifying the process of the RGBW four-color color filter layer and raises the production efficiency. Furthermore, since the white color resist has been replaced by the color filter, the omission of the white color resist can save the material costs of the color filter substrate.

The purpose of the present invention and the aforementioned technical problem to be solved can be realized by the following technical embodiments. The present invention provides a display panel comprising a first substrate, a second substrate disposed in parallel with the first substrate, a light shielding layer disposed on the first substrate and defined a plurality of pixel areas, a color filter layer disposed on the plurality of pixel areas. The color filter layer comprises a first colored resist layer, a second colored resist layer, a third colored resist layer and a fourth colored resist layer. A transparent electrode layer disposed on the color filter layer. Wherein the fourth colored resist layer comprises a plurality of different colored resistor materials sequentially stacked from bottom to top.

In one embodiment of the present invention, the plurality of different colored resistor materials comprise a combination material consisting of at least two of the first colored resist layer, the second colored resist layer and the third colored resist layer.

In one embodiment of the present invention, a cross sectional area of each of the plurality of different colored resistor materials is substantially the same,

In one embodiment of the present invention, a thickness of each of the plurality of different colored resistor materials is substantially the same, or different, or partially the same.

In one embodiment of the present invention, a light source emitting a light through the fourth colored resist layer to generate a white light or a yellow light.

The purpose of the present invention and the aforementioned technical problem to be solved can be further realized by the following technical embodiments.

Another object of the present invention is to provide a method of manufacturing a display panel comprising: providing a first substrate and a second substrate opposing disposed, forming a light shielding layer on the first substrate and the light shielding layer defined a plurality of pixel areas, forming a first colored resist layer, a second colored resist layer, a third colored resist layer and a fourth colored resist layer on the plurality of pixel areas so as to form a color filter layer, wherein the fourth colored resist layer comprises a plurality of different colored resistor materials sequentially stacked from bottom to top, and forming a transparent electrode layer on the first substrate and covering the color filter layer.

In one embodiment of the present invention, the plurality of different colored resistor materials comprises a combination material consisting of at least two of the first colored resist layer, the second colored resist layer and the third colored resist layer.

In one embodiment of the present invention, the fourth colored resist layer is formed by stacking the plurality of different colored resistor materials while forming the first colored resist layer, the second colored resist layer and the third colored resist layer on the plurality of pixel areas.

In one embodiment of the present invention, a cross sectional area of each of the plurality of different colored resistor materials is substantially the same.

In one embodiment of the present invention, a thickness of each of the plurality of different colored resistor materials is substantially the same, or different, or partially the same.

Another object of the present invention is to provide a display panel comprising a first substrate, a second substrate disposed in parallel with the first substrate, a light shielding layer disposed on the first substrate and defined a plurality of pixel areas, a color filter layer disposed on the plurality of pixel areas, the color filter layer including a first colored resist layer, a second colored resist layer, a third colored resist layer and a fourth colored resist layer, and a transparent electrode layer disposed on the color filter layer; wherein the first colored resist layer is red colored resist material, the second colored resist layer is green colored resist material, the third colored resist layer is blue colored resist material; and wherein, the fourth colored resist layer comprises a plurality of different colored resistor materials sequentially stacked from bottom to top.

The present invention provides a display panel and a method for manufacturing the same, simplifying the process of the RGBW four-color color filter layer and raising the production efficiency. Furthermore, since the white color resist has been replaced by the structural design of the color filter, the omission of the white color resist can save the material costs of the color filter substrate.

Various other objects, advantages and features of the present invention will become readily apparent from the ensuing detailed description, and the novel features will be particularly pointed out in the appended claims.

### BRIEF DESCRIPTION OF FIGURES

The following detailed descriptions, given by way of example, and not intended to limit the present invention solely thereto, will be best be understood in conjunction with the accompanying figures:

FIGS. 1-3 are schematic structural diagram showing a liquid crystal display panel manufacturing processes according to one embodiment of the present invention;

FIG. 4 is schematic diagram showing a light transmitting pathway in a liquid crystal display panel according to one embodiment of the present invention;

FIGS. 5-7 are schematic structural diagram showing a liquid crystal display panel manufacturing processes according to another embodiment of the present invention; and

FIG. 8 is schematic diagram showing a light transmitting pathway in a liquid crystal display panel according to another embodiment of the present invention.

### DETAILED DESCRIPTION OF THE EMBODIMENTS

The following embodiments are referring to the accompanying drawings for exemplifying specific implementable embodiments of the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

The drawings and description are to be regarded as illustrative in nature and not restrictive. Like reference numerals designate like elements throughout the specification. In addition, the size and thickness of each component shown in the drawings are arbitrarily shown for understanding and ease of description, but the present invention is not limited thereto.

In the drawings, the thickness of layers, films, panels, regions, etc., are exaggerated for clarity. In the drawings, for understanding and ease of description, the thicknesses of some layers and areas are exaggerated. It will be understood that, when an element such as a layer, film, region, or substrate is referred to as being “on” another element, it can be directly on the other element or intervening elements may also be present.

Furthermore, in the specification, “on” implies being positioned above or below a target element and does not imply being necessarily positioned on the top on the basis of a gravity direction.

For further explaining the technical means and efficacy of the present application intended to file, a liquid crystal display panel and a method for manufacturing the same including the embodiments, structures, features and effects thereof according to the present invention will be apparent from the following detailed description and accompanying drawings.

A liquid crystal display panel of the present invention comprises an active array switch substrate, a color filter layer substrate and a liquid crystal layer disposed between the active array switch substrate and the color filter layer substrate.

In one embodiment, the display panel of the present invention is a curved liquid crystal display panel.

In one embodiment, the active array switch (Thin Film Transistor, TFT) and the color filter layer (CF) of the present invention are formed on the same substrate.

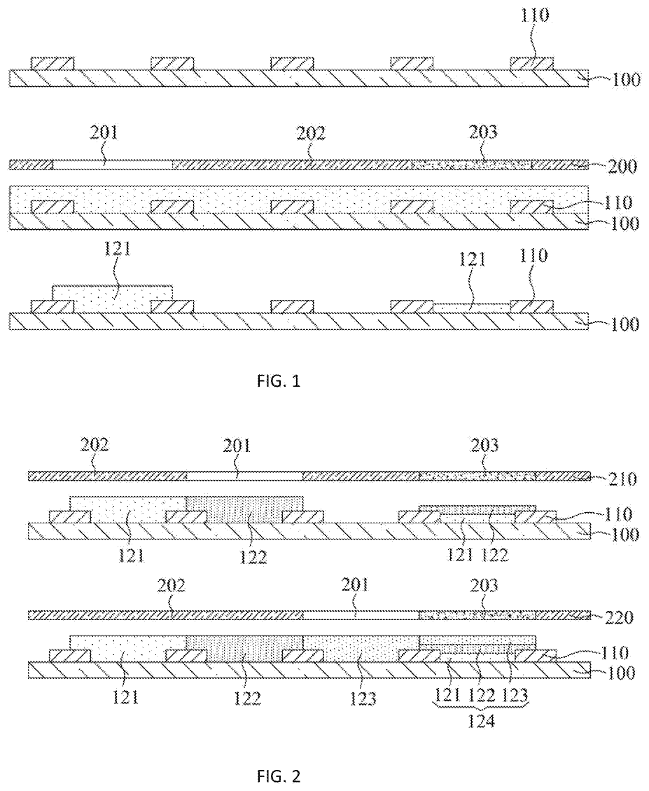

FIGS. 1-3 are schematic structural diagram showing a liquid crystal display panel manufacturing processes according to one embodiment of the present invention. Referring to FIGS. 1, 2 and 3, in one embodiment of the present invention, a method of manufacturing a display panel 10 comprises: providing a first substrate 100 and a second substrate (not shown) opposing disposed, forming a light shielding layer 110 on the first substrate 100 and the light shielding layer 110 defined a plurality of pixel areas, forming a first colored resist layer 121, a second colored resist layer 122, a third colored resist layer 123 and a fourth colored resist layer 124 on the plurality of pixel areas so as to form a color filter layer, wherein the fourth colored resist layer 124 includes a plurality of different colored resistor materials sequentially stacked from bottom to top, and a transparent electrode layer 130 is formed on the first substrate 100 and covers the color filter layer.

In one embodiment, the first colored resist layer 121 may be the red colored resist material, the second colored resist layer 122 may be the green colored resist material, and the third colored resist layer 123 may be the blue colored resist material, for example.

In one embodiment, the plurality of different colored resistor materials comprises a combination material consisting of at least two of the first colored resist layer 121, the second colored resist layer 122 and the third colored resist layer 123. In the present embodiment, the fourth colored resist layer comprises three different colored resistor materials, the three different colored resistor materials include the red colored resist material, the green colored resist material and the blue colored resist material.

In one embodiment, the first colored resist layer 121, the second colored resist layer 122 and the third colored resist layer 123 are formed on the plurality of pixel areas by photolithography processes with the masks 200, 210, 220 correspondingly. The fourth colored resist layer 124 is formed simultaneously with the photolithography processes of forming the first colored resist layer 121, the second colored resist layer 122 and the third colored resist layer 123 through the stacking of the plurality of different colored resistor materials on the plurality of pixel areas.

In one embodiment, the cross-sectional area of the stacked the plurality of different colored resistor materials has an effective display area equal to the light transmitting area of a sub-pixel without shielded by the light shielding layer 110.

In one embodiment, a thickness of each of the plurality of different colored resistor materials is substantially the same, or different, or partially the same.

In one embodiment, the light shielding layer 110 is a black matrix layer to distinguish the plurality of different colored resist layers from each other so as to prevent color mixing and to improve the displaying performance.

In one embodiment, the second substrate (not shown) is an active array switch substrate such as Thin Film Transistor substrate (TFT substrate).

In one embodiment, the mask 200, 210, 220 includes a light transmitting region 201 and a light shielding region 202, and a semi-transmitting region 203 with the light transmittance in a range from 0.5% to 3%.

Referring to FIGS. 1, 2 and 3, a display panel 10 comprises a first substrate 100, a second substrate (not shown) disposed in parallel with the first substrate, a light shielding layer 110 disposed on the first substrate 100 and defined a plurality of pixel areas, a color filter layer disposed on the plurality of pixel areas, the color filter layer including a first colored resist layer 121, a second colored resist layer 122, a third colored resist layer 123 and a fourth colored resist layer 124; wherein the fourth colored resist layer 124 has a plurality of different colored resistor materials sequentially stacked from bottom to top; and a transparent electrode layer 130 disposed on the color filter layer.

In one embodiment, the first colored resist layer 121 may be the red colored resist material, the second colored resist layer 122 may be the green colored resist material, and the third colored resist layer 123 may be the blue colored resist material, for example.

In one embodiment, the plurality of different colored resistor materials comprises a combination material consisting of at least two of the first colored resist layer 121, the second colored resist layer 122 and the third colored resist layer 123. In the present embodiment, the fourth colored resist layer 124 comprises three different colored resistor materials, the three different colored resistor materials include the red colored resist material, the green colored resist material and the blue colored resist material.

In one embodiment, the cross-sectional area of the stacked the plurality of different colored resistor materials has an effective display area equal to the light transmitting area of a sub-pixel without shielded by the light shielding layer.

In one embodiment of the present invention, a thickness of each of the plurality of different colored resistor materials is substantially the same, or different, or partially the same.

In one embodiment, the light shielding layer 110 is a black matrix layer to distinguish the plurality of different colored resist layers from each other so as to prevent color mixing and to improve the displaying performance.

In one embodiment, the second substrate (not shown) is an active array switch substrate such as Thin Film Transistor substrate (TFT substrate).

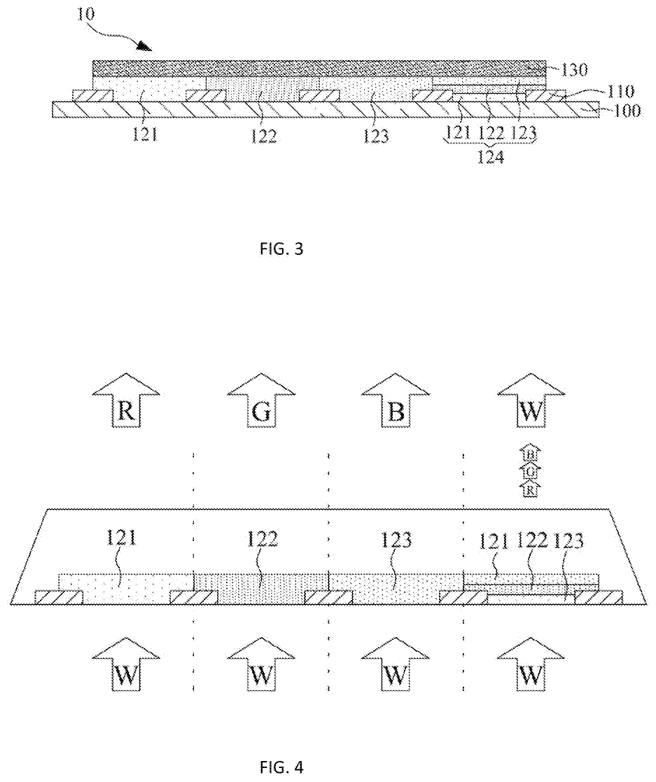

FIG. 4 is schematic diagram showing a light transmitting pathway in a liquid crystal display panel 10 according to one embodiment of the present invention, in the present embodiment, the liquid crystal display panel 10 is irradiated by a light source W. In the meanwhile, the first colored resist layer (red colored resist material) 121 is exposed to red light R, the second colored resist layer (green colored resist material) 122 is exposed to green light G, and the third colored resist layer (blue colored resist material) 123 is exposed to blue B. The fourth colored resist layer 124 is designed by stacking the three layers of the colored resistor materials with red, green and blue colors, and the light finally transmitted out of the fourth colored resist layer 124 is white light W according to the principle of the three primary colors mixed light. The designers can determinate the final transparent white light of the fourth colored resist layer toward to a certain color system, such as a yellow color system, a purple color system and the like, according to different thicknesses of the three layers of the colored resistor materials with red, green and blue colors, so that to make the fourth colored resist layer suitable for different needs.

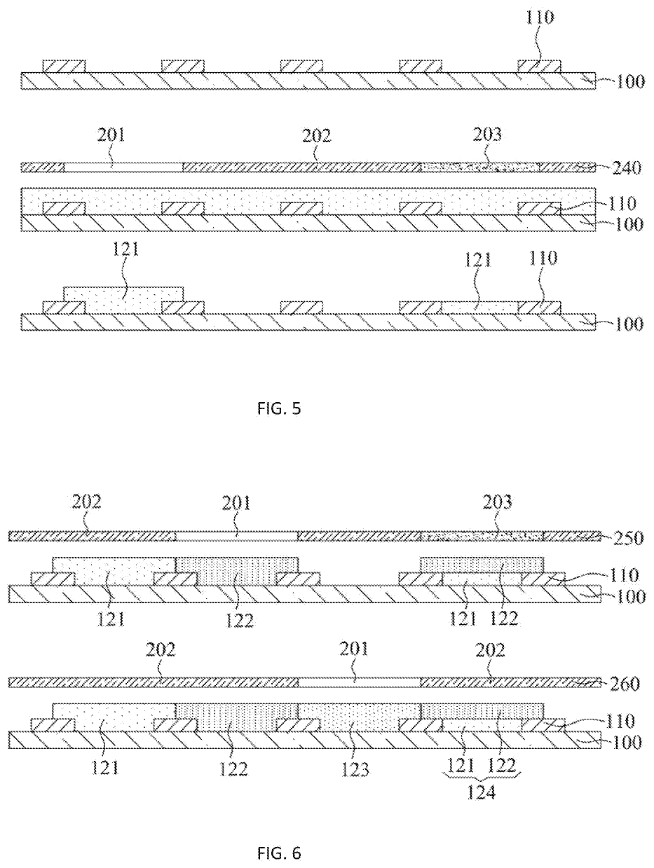

FIGS. 5-7 are schematic structural diagram showing a liquid crystal display panel manufacturing processes according to another embodiment of the present invention, referring to FIGS. 5-7, in one of the present embodiments, a method of manufacturing a display panel 20 comprises: providing a first substrate 100 and a second substrate (not shown) opposing disposed, forming a light shielding layer 110 on the first substrate 100 and the light shielding layer 110 defined a plurality of pixel areas, forming a first colored resist layer 121, a second colored resist layer 122, a third colored resist layer 123 and a fourth colored resist layer 124 on the plurality of pixel areas so as to complete a color filter layer, wherein the fourth colored resist layer 124 includes a plurality of different colored resistor materials sequentially stacked from bottom to top, and forming a transparent electrode layer 130 on the first substrate 100 and covering the color filter layer.

In one embodiment, the first colored resist layer 121 may be the red colored resist material, the second colored resist layer 122 may be the green colored resist material, and the third colored resist layer 123 may be the blue colored resist material, for example.

In one embodiment, the plurality of different colored resistor materials comprises a combination material consisting of at least two of the first colored resist layer 121, the second colored resist layer 122 and the third colored resist layer 123. In the present embodiment, the fourth colored resist layer 124 comprises two different colored resistor materials. In the present embodiment, the two different colored resistor materials include the red colored resist material and the green colored resist material.

In one embodiment, the first colored resist layer 121 and the second colored resist layer 122 are formed on the plurality of pixel areas by photolithography processes with the masks 240, 250 correspondingly. The fourth colored resist layer 124 is formed simultaneous with the photolithography processes of forming the first colored resist layer 121 and the second colored resist layer 122 through the stacking of the plurality of different colored resistor materials on the plurality of pixel areas. And then the third colored resist layer 123 is formed on the plurality of pixel areas by the photolithography process with the masks 260.

In one embodiment, the cross-sectional area of the stacked the plurality of different colored resistor materials has an effective display area equal to the light transmitting area of a sub-pixel without shielded by the light shielding layer 110.

In one embodiment of the present invention, a thickness of each of the plurality of different colored resistor materials is substantially the same, or different, or partially the same.

In one embodiment, the light shielding layer 110 is a black matrix layer to distinguish the plurality of different colored resist layers from each other so as to prevent color mixing and to improve the displaying performance.

In one embodiment, the second substrate (not shown) is an active array switch substrate such as Thin Film Transistor substrate (TFT substrate).

In one embodiment, the mask 240, 250 includes a light transmitting region 201 and a light shielding region 202, and a semi-transmitting region 203 with the light transmittance in a range from 0.5% to 3%. Furthermore, the mask 260 for forming the third colored resist layer 123 includes a light transmitting region 201 and a light shielding region 202.

Referring to FIGS. 5-7 again, a display panel 20 comprises a first substrate 100, a second substrate (not shown) disposed in parallel with the first substrate, a light shielding layer 110 disposed on the first substrate 100 and defined a plurality of pixel areas, a color filter layer disposed on the plurality of pixel areas, the color filter layer including a first colored resist layer 121, a second colored resist layer 122, a third colored resist layer 123 and a fourth colored resist layer 124; wherein the fourth colored resist layer 124 having a plurality of different colored resistor materials sequentially stacked from bottom to top; and a transparent electrode layer 130 disposed on the color filter layer.

In one embodiment, the first colored resist layer 121 may be the red colored resist material, the second colored resist layer 122 may be the green colored resist material, and the third colored resist layer 123 may be the blue colored resist material, for example.

In one embodiment, the plurality of different colored resistor materials comprises a combination material consisting of at least two of the first colored resist layer 121, the second colored resist layer 122 and the third colored resist layer 123. In the present embodiment, the fourth colored resist layer 124 comprises two different colored resistor materials, the two different colored resistor materials include the red colored resist material and the green colored resist material.

In one embodiment, the cross-sectional area of the stacked the plurality of different colored resistor materials has an effective display area equal to the light transmitting area of a sub-pixel without shielded by the light shielding layer 110.

In one embodiment of the present invention, a thickness of each of the plurality of different colored resistor materials is substantially the same, or different, or partially the same.

In one embodiment, the light shielding layer 110 is a black matrix layer to distinguish the plurality of different colored resist layers from each other so as to prevent color mixing and to improve the displaying performance.

In one embodiment, the second substrate (not shown) is an active array switch substrate such as Thin Film Transistor substrate (TFT substrate).

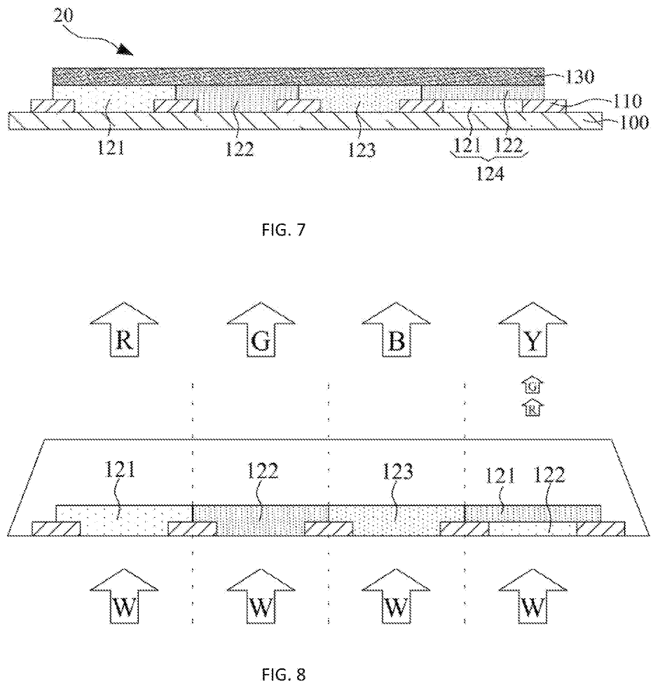

FIG. 8 is schematic diagram showing a light transmitting pathway in a liquid crystal display panel 20 according to another embodiment of the present invention. In the meanwhile, the first colored resist layer (red colored resist material) 121 is exposed to red light R, the second colored resist layer (green colored resist material) 122 is exposed to green light G, and the third colored resist layer (blue colored resist material) 123 is exposed to blue B. The fourth colored resist layer 124 is designed by stacking the two layers of the colored resistor materials with red and green, and the light finally transmitted out of the fourth colored resist layer 124 is yellow light Y according to the principle of the three primary colors mixed light.

In one embodiment, the fourth colored resist layer 124 may also be, for example, a dual layer structure of a red colored resist material and a blue colored resist material, or a dual layer structure of a green colored resist material and a blue colored resist material. The light transmitted by the fourth colored resist layer 124 is magenta light or cyan light by the combination of different colored resistor materials. And by adjusting the thickness of the colored resistor materials of the dual layer to make the final transparent light of the fourth colored resist layer 124 toward to a certain color system. The embodiments of the present application are illustrated by way of example, but not to limit, the arrangement of the fourth colored resist layer 124 is depend on the design of the designer.

By means of the simplified design of the color filter layer and the employment of the principle of the three primary colors mixed light, it simplifies the process of the RGBW four-color color filter layer and raises the production efficiency. Furthermore, since the white color resist been replaced by the structural design of the color filter, the omission of the white color resist it can save the material costs of the color filter substrate.

In addition, in the specification, unless explicitly described to the contrary, the word “comprise” and variations such as “comprises” or “comprising” will be understood to imply the inclusion of stated elements but not the exclusion of any other elements.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A display panel, comprising:
a first substrate;
a second substrate, disposed in parallel with the first substrate;
a light shielding layer, disposed on the first substrate and defined a plurality of pixel areas;
a color filter layer, disposed on the plurality of pixel areas, including a first colored resist layer, a second colored resist layer, a third colored resist layer and a fourth colored resist layer; and
a transparent electrode layer, disposed on the color filter layer;
wherein the fourth colored resist layer comprises a plurality of different colored resistor materials sequentially stacked from bottom to top.

2. The display panel according to claim 1, wherein the plurality of different colored resistor materials comprise a combination material consisting of at least two of the first colored resist layer, the second colored resist layer and the third colored resist layer.

3. The display panel according to claim 1, wherein a cross sectional area of each of the plurality of different colored resistor materials is substantially the same.

4. The display panel according to claim 1, wherein a thickness of each of the plurality of different colored resistor materials is substantially the same.

5. The display panel according to claim 1, wherein a thickness of each of the plurality of different colored resistor materials is different.

6. The display panel according to claim 1, wherein each of the plurality of different colored resistor materials has an area having the same thickness.

7. The display panel according to claim 1, further comprising a light source emitting a light through the fourth colored resist layer to generate a white light or a yellow light.

8. A method of manufacturing a display panel, comprising steps of:
providing a first substrate and a second substrate opposing disposed;
forming a light shielding layer on the first substrate, the light shielding layer defined a plurality of pixel areas;
forming a first colored resist layer, a second colored resist layer, a third colored resist layer and a fourth colored resist layer on the plurality of pixel areas so as to form a color filter layer, wherein the fourth colored resist layer comprises a plurality of different colored resistor materials sequentially stacked from bottom to top; and
forming a transparent electrode layer on the first substrate and covering the color filter layer.

9. The method of manufacturing a display panel according to claim 8, wherein the plurality of different colored resistor materials comprise a combination material consisting of at least two of the first colored resist layer, the second colored resist layer and the third colored resist layer.

10. The method of manufacturing a display panel according to claim 8, wherein the fourth colored resist layer is formed by stacking the plurality of different colored resistor materials while forming the first colored resist layer, the second colored resist layer and the third colored resist layer on the plurality of pixel areas.

11. The method of manufacturing a display panel according to claim 8, wherein a cross sectional area of each of the plurality of different colored resistor materials is substantially the same.

12. The method of manufacturing a display panel according to claim 8, wherein a thickness of each of the plurality of different colored resistor materials is substantially the same.

13. The method of manufacturing a display panel according to claim 8, wherein a thickness of each of the plurality of different colored resistor materials is different.

14. The method of manufacturing a display panel according to claim 8, wherein each of the plurality of different colored resistor materials has an area having the same thickness.

15. A display panel, comprising:
a first substrate;
a second substrate, disposed in parallel with the first substrate;
a light shielding layer, disposed on the first substrate and defined a plurality of pixel areas;
a color filter layer, disposed on the plurality of pixel areas, including a first colored resist layer, a second colored resist layer, a third colored resist layer and a fourth colored resist layer; and
a transparent electrode layer, disposed on the color filter layer;
wherein the first colored resist layer is red colored resist material, the second colored resist layer is green colored resist material, and the third colored resist layer is blue colored resist material; and
wherein the fourth colored resist layer comprises a plurality of different colored resistor materials sequentially stacked from bottom to top.
